(19) United States
(12) Patent Application Publication
(10) Pub. No.: US 2025/0218315 A1
(43) Pub. Date: Jul. 3, 2025

(54) TOOL FOR USE WITH A MOUNTED POSTER DISPLAY

(71) Applicant: Marketing Displays, Inc., FArmington Hills, MI (US)

(72) Inventors: Dafne Yasmina PETRIZ-LOPEZ, South Lyon, MI (US); Carlo Eduardo Avina SANCHEZ, Detroit, MI (US); Jonathan Luke KLAUTKY, Farmington Hills, MI (US)

(73) Assignee: Marketing Displays, Inc., Farmington Hills, MI (US)

(21) Appl. No.: 18/881,414

(22) PCT Filed: Jul. 14, 2023
(86) PCT No.: PCT/US2023/027797

§ 371 Date: Jan. 6, 2025

Related U.S. Application Data
(60) Provisional application No. 63/445,177, filed on Feb. 13, 2023.
(60) Provisional application No. 63/389,336, filed on Jul. 14, 2022.

(51) Int. Cl. G09F 15/02; B25G 1/04; G09F 15/00

(52) U.S. Cl. CPC G09F 15/025; B25G 1/04; G09F 15/0012

(57) ABSTRACT

A frame tool for placing a poster in a poster display or removing the poster from the poster display includes a head having a first major panel that opposes a second major panel. The first major panel and the second major panel are connected to a top end that includes an angled recess. The first major panel may include a concave surface connected to the top end. The second major panel may include a fulcrum disposed away from the top end.

### CROSS-REFERENCE TO RELATED APPLICATIONS

The application claims the benefits of U.S. Provisional Application No. 63/389,336, filed Jul. 14, 2022, and U.S. Provisional Application No. 63/445,177, filed Feb. 13, 2023. The entire disclosures of the above applications are incorporated herein by reference.

### FIELD

The present disclosure relates to a tool for use with a mounted poster display.

### BACKGROUND

This section provides background information related to the present disclosure which is not necessarily prior art.

A poster display is often used to display content. The poster display may include a frame configured to receive a poster. The poster may display the content and be secured to the frame. In some examples, the poster display may be used in a commercial setting. More specifically, the poster display may be used as a point of purchase advertising tool where a retailer displays content to advertise a product. For example, the poster display may provide content relating to the price of a product. In another example, the poster display may provide content relating to a new product that is available.

In some examples, there may be a need to replace the poster within the frame. However, the location of the poster display can make replacing the poster a challenge. For example, the poster display may be located in a window of a building that is several feet from the ground. Current methods to replace the poster in such example include using a ladder to remove the poster display from the window of the building, bring the poster display back to the ground level, replace the poster within the frame, and re-hang the poster using the ladder. This is a cumbersome and inefficient process.

The present disclosure provides an effective system for replacing a poster from a frame without the need for a ladder.

### SUMMARY

This section provides a general summary of the disclosure and is not a comprehensive disclosure of its full scope or all of its features.

In at least one example embodiment, the present disclosure provides a frame tool for placing a poster in a poster display or removing the poster from the poster display. The frame tool may include a head having a first major panel that opposes a second major panel. The first major panel and the second major panel may be connected to a top end. The top end may include an angled recess. The first major panel may include a concave surface.

In at least one example embodiment, the frame tool may further include a pole attachment that defines a bottom end of the head away from the top end and may be configured to receive a pole.

In at least one example embodiment, the pole attachment may further include a plurality of threads on an interior, receiving surface that may be configured to engage the pole.

In at least one example embodiment, the first major panel may further include a first substantially planar surface coupled to the concave surface and may be substantially parallel with a second substantially planar surface of the second major panel.

In at least one example embodiment, the first and second substantially planar surfaces may be substantially parallel with a major axis of the pole attachment.

In at least one example embodiment, the frame tool may further include a sloped collar that is configured to connect the pole attachment to the first substantially planar surface and the second substantially planar surface.

In at least one example embodiment, the second substantially planar surface may be a first rear surface and the second major panel may further include a second rear surface that is coupled to the top end and a third rear surface disposed between the first and second rear surfaces.

In at least one example embodiment, the second rear surface may be angled inward towards the first major panel.

In at least one example embodiment, an angle between a minor axis of the pole attachment and a major axis of the second rear surface may be greater than or equal to about 30 degrees to less than or equal to about 70 degrees.

In at least one example embodiment, an angle between a minor axis of the pole attachment and a portion of the concave surface coupled to the top end may be greater than or equal to about 28 degrees to less than or equal to about 68 degrees.

In at least one example embodiment, the first major panel may further include one or more bumpers extending from the concave surface.

In at least one example embodiment, the one or more bumpers may extend from a portion of the concave surface adjacent to the top end.

In at least one example embodiment, the head may be formed of a first material, and the one or more bumpers may include a second material different from the first material.

In at least one example embodiment, the head may be formed of a first material, and the one or more bumpers may be at least partially coated with a second material.

In at least one example embodiment, the second major panel may include a fulcrum.

In at least one example embodiment, the fulcrum may include a peak having a height greater than or equal to about 12.7 mm to less than or equal to about 25.4 mm.

In at least one example embodiment, the head may be formed of a first material, and the fulcrum may include a second material different from the first material.

In at least one example embodiment, the head may be formed of a first material, and the fulcrum may be at least partially coated with a second material.

In at least one example embodiment, the second material may be at least partially coating the second major plane.

In at least one example embodiment, the angle recess may include a first length and a second length that join together at respective first ends to form a point, an angle between a second end of the first length and a second end of the second length may be greater than or equal to about 35 degrees to less than or equal to about 60 degrees, where the second end of the first length being a further position of the first length from the point, and the second end of the second length being a further position of the second length from the point.

In at least one example embodiment, the present disclosure provides a system for placing a poster in a poster display. The system may include a frame having a top panel, a bottom panel, and lateral side panels connecting the top and bottom panels to define an opening, each of the panels may be movable between an open position and a closed position; a frame tool having a first head and a first pole attached to the first head, the frame tool may be operable to move the panels of the frame between the open and closed positions; and a poster tool having a second head and a second pole attached to the second head, the second head may include a curved receiver having a slot, the curved receiver may be configured to receive the poster within the slot, and movement of the poster tool from the top panel to the bottom panel of the frame may be operable to position the poster within the opening of the frame.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of an example poster display having a frame and poster in accordance with at least one example embodiment of the present disclosure;

FIG. 2 is a partial perspective view of the frame illustrated in FIG. 1 where a first panel is an opened position and a second panel is in a closed position in accordance with at least one example embodiment of the present disclosure;

FIG. 3 is a perspective view of an example frame tool in accordance with at least one example embodiment the present disclosure;

FIG. 4 is a side view of the frame tool illustrated in FIG. 3;

FIG. 5 is a back view of the frame tool illustrated in FIG. 3;

FIG. 6 is a side view of an example pole in accordance with at least one example embodiment of the present disclosure;

FIG. 7 is a perspective view of the pole illustrated in FIG. 6;

FIG. 8 is a perspective view of an example poster tool in accordance with at least one example embodiment of the present disclosure;

FIG. 9 is a side view of the poster tool illustrated in FIG. 8;

FIG. 10 is a back view of the poster tool illustrated in FIG. 8;

FIG. 11 is an image illustrating an example frame tool (like the frame tool illustrated in FIG. 3) positioned under a first panel of an example frame (like the frame illustrated in FIG. 1) when the first panel is in a closed position in accordance with at least one example embodiment of the present disclosure;

FIG. 12 is an image illustrating the frame tool (for example, as illustrated in FIG. 11) positioned under the first panel as the first panel moves from the closed position to an open position in accordance with at least one example embodiment of the present disclosure;

FIG. 13 is an image illustrating the frame tool (for example, as illustrated in FIG. 11) positioned under the first panel when the first panel is in the open position in accordance with at least one example embodiment of the present disclosure;

FIG. 14 is an image illustrating the frame tool (for example, as illustrated in FIG. 11) positioned under a second panel of the frame when the second panel is in the closed position in accordance with at least one example embodiment of the present disclosure;

FIG. 15 is an image illustrating the frame tool (for example, as illustrated in FIG. 11) positioned under the second panel when the second panel is in the open position in accordance with at least one example embodiment of the present disclosure;

FIG. 16 is an image illustrating an example poster positioned within a head of an example poster tool (like the poster tool illustrated in FIG. 8) in accordance with at least one example embodiment of the present disclosure;

FIG. 17 is an image illustrating the poster positioned within a first panel of a frame (like the frame illustrated in FIG. 1) in accordance with at least one example embodiment of the present disclosure;

FIG. 18 is an image illustrating an example method for securing a poster to a frame (like the frame illustrated in FIG. 1) using a frame tool (like the frame tool illustrated in FIG. 3) and a poster tool (like the poster tool illustrated in FIG. 8) in accordance with at least one example embodiment of the present disclosure;

FIG. 19 is an image illustrating the frame tool (for example, as illustrated in FIG. 11) positioned on top of the second panel when the second panel is in the open position in accordance with at least one example embodiment of the present disclosure;

FIG. 20 is an image illustrating the frame tool (for example, as illustrated in FIG. 11) positioned on top of the second panel when the second panel is in the closed position in accordance with at least one example embodiment of the present disclosure.

FIG. 21 is a top-down perspective view of another example frame tool in accordance with at least one example embodiment the present disclosure;

FIG. 22 is a perspective view of the frame tool illustrated in FIG. 21; FIG. 23 is a sideview of the frame tool illustrated in FIG. 21;

FIG. 24 is a rear view of the frame tool illustrated in FIG. 21;

FIG. 25A is a front view of the frame tool illustrated in FIG. 21;

FIG. 25B is a front view of the frame tool illustrated in FIG. 21;

FIG. 26A is a cross-sectional view of the frame tool illustrated in FIG. 25A along line A-A;

FIG. 26B is a cross-sectional view of the frame tool illustrated in FIG. 25B along line A-A;

FIG. 27A is an image illustrating an example frame tool (like the frame tool illustrated in FIG. 21) aligned with a receiving surface of a first panel of an example frame (like the frame illustrated in FIG. 1) when the first panel is in a closed position in accordance with at least one example embodiment of the present disclosure;

FIG. 27B is an image illustrating the frame tool (for example, as illustrated in FIG. 27A) interfacing with the receiving surface of the first panel as the first panel moves from the closed position to an open position in accordance with at least one example embodiment of the present disclosure;

FIG. 27C is another image illustrating the frame tool (for example, as illustrated in FIG. 27A) interfacing with the receiving surface of the first panel as the first panel moves from the closed position to an open position in accordance with at least one example embodiment of the present disclosure;

FIG. 27D is an image illustrating the frame tool (for example, as illustrated in FIG. 27A) interfacing with the receiving surface of the first panel when the first panel is in the open position in accordance with at least one example embodiment of the present disclosure;

FIG. 28A is an image illustrating an example frame tool (like the frame tool illustrated in FIG. 21) aligned with an exterior-facing surface of the first panel when the first panel is in the open position in accordance with at least one example embodiment of the present disclosure;

FIG. 28B is an image illustrating the frame tool (for example, as illustrated in FIG. 28A) interfacing with the exterior-facing surface of the first panel as the first panel moves from the open position to the closed position in accordance with at least one example embodiment of the present disclosure;

FIG. 28C is another image illustrating the frame tool (for example, as illustrated in FIG. 28A) interfacing with the exterior-facing surface of the first panel as the first panel moves from the open position to the closed position in accordance with at least one example embodiment of the present disclosure; and

FIG. 28D is an image illustrating the frame tool (for example, as illustrated in FIG. 28A) interfacing with the exterior-facing surface of the first panel when the first panel is in the closed position in accordance with at least one example embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Example embodiments will now be described more fully with reference to the accompanying drawings.

The present disclosure provides effective systems for replacing a first poster in the frame with a second poster in the frame, without the need for a ladder or similar structure, using a frame and poster tools that can be operated from a distance by a single user. With reference to

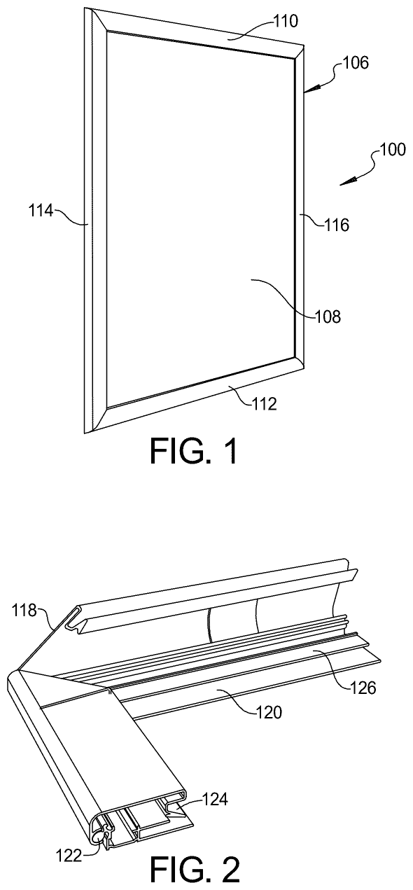

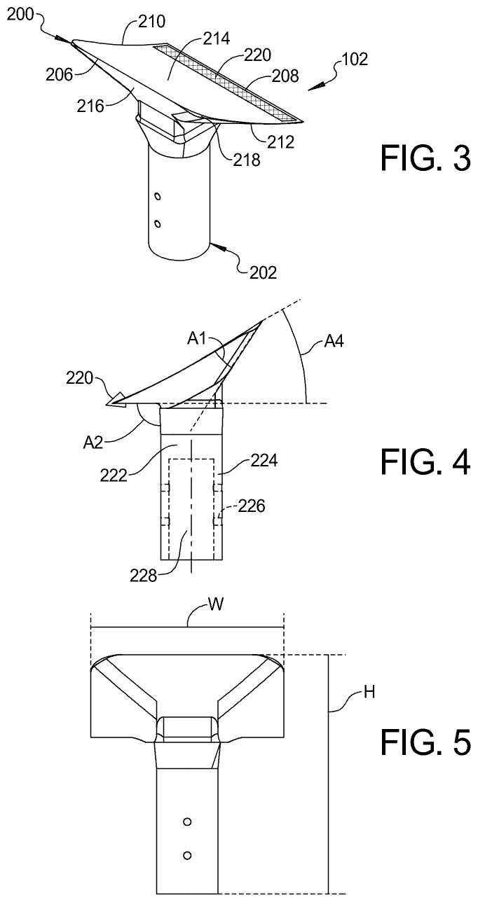

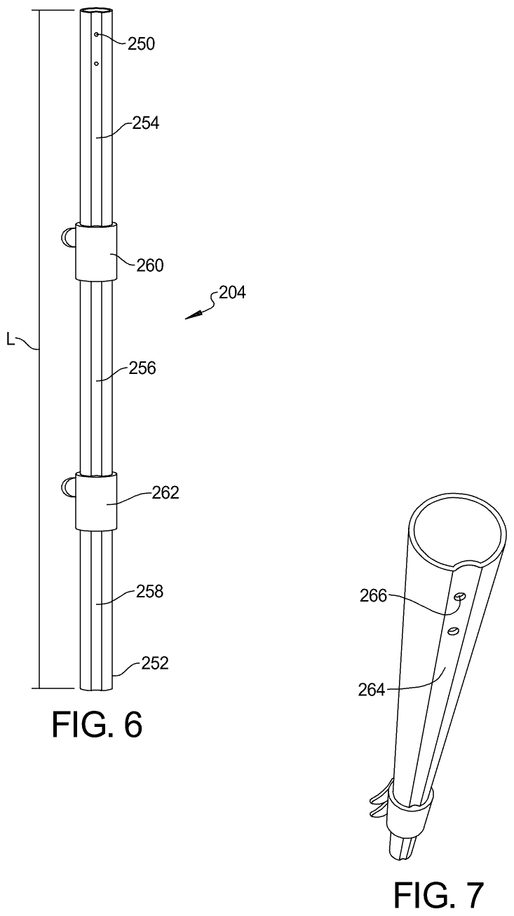

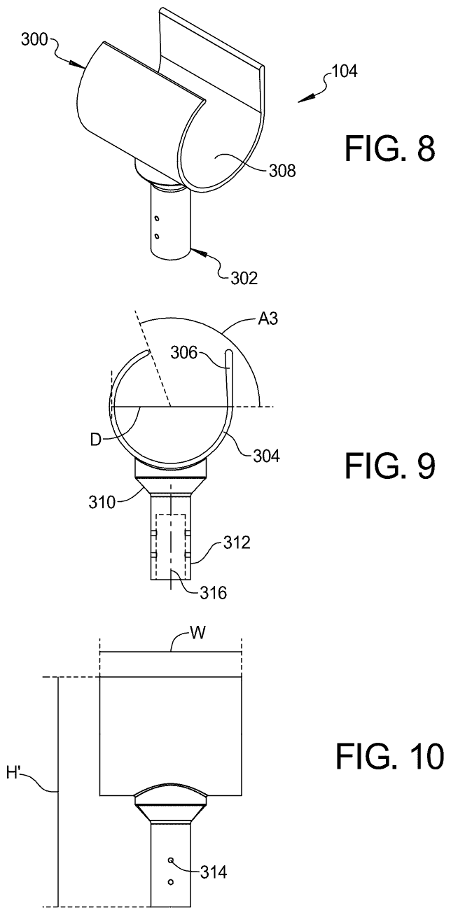

FIGS. 1-10, an example poster replacement system is provided. The poster replacement system includes a poster display 100 (FIGS. 1-2), a frame tool 102 (FIGS. 3-7), and a poster tool 104 (FIGS. 6-10). The poster display 100 includes a frame 106 and a poster 108. The frame tool 102 and the poster tool 104 may be operable to replace a first poster in the frame 106 with a second poster.

In at least one example embodiment, the frame 106 may be a front-loading snap frame. Front loading snap frames may have, for example, spring loaded frame sides that snap open and closed to apply or remove the poster. Such front-loading snap frames can be of the type manufactured and sold by MDI Worldwide, Inc. under the registered mark PosterGrip®.

In at least one example embodiment, the frame 106 may include a top panel 110, a bottom panel 112, and lateral side panels 114, 116 that joins the top and bottom panels 110, 112. Each of the panels 110, 112, 114, 116 may include a first portion 118, a second portion 120, and a hinge 122. The first and second portions 118, 120 may be movably coupled to the hinge 122 at ends of the first and second portions 118, 120. The first portion 118 may include a first protrusion 124 at an end opposite from hinge 122, and the second portion 120 may include a second protrusion 126. The hinge 122 may include a pivot hinge, a living hinge, a flexible hinge, or the like. The top, bottom, and lateral side panels 110, 12, 114, 116 may define an opening within the frame 106. The poster may be positioned within the opening of the frame 106. The poster may be secured to each panel 110, 112, 114, 116 of the frame 106 between the first and second portions 118, 120.

With reference to FIGS. 3-7, a frame tool 102 may include a head 200 (FIGS. 3-5), a pole attachment 202 (FIGS. 3-5), and a pole 204 (FIGS. 6-7). The head 200 of the frame tool 102 may include a may include a top side 206, a bottom side 208, and lateral sides 210, 212 connecting the top and bottom side 206, 208 to define a contact surface 214 and a back surface 216. Corners 218 may be positioned at a location where the top side 206 and lateral sides 210, 212 meet and where the lateral sides 210, 212 and bottom side 208 meet. The corners 218 may be rounded. The head 200 of the frame tool 102 may have a width W measured between the lateral sides. In at least one example embodiment, the width W may range from about four inches to about six inches.

Each of the sides 206, 208, 210, 212 of the head 200 may have a pointed edge. The pointed edges may have an angle A1 between the contact surface 214 and the back surface 216. In at least one example embodiment, angle A1 may range from about ten degrees to about thirty degrees. In at least one example embodiment, the contact surface 214 may be a curved surface. In at least one example embodiment, the contact surface 214 may be a flat surface. The contact surface 214 may have an angle A4 measured from the contact surface 214 to a horizontal plane. In at least one example embodiment, the angle A4 may range from approximately 20 degrees to approximately 40 degrees.

Additionally, the head 200 of the frame tool 102 may include a friction material 220 disposed on the head 200. The friction material 220 may be disposed on the entirety of the head 200, or on less than all of the head 200. In at least one example embodiment, for example as illustrated in FIG. 3, the friction material 220 may be disposed on the contact surface 214 extending between the lateral sides 210, 212 and positioned adjacent to the bottom side 208. In at least one example embodiment, for example as shown in FIG. 4, the friction material 220 may be disposed at the bottom side 208 and extend to the contact and back surfaces 214, 216. The friction material 220 may be composed of any material having a friction property. For example, the friction material 220 may be rubber. More specifically, the friction material 220 may be neoprene.

The pole attachment 202 may be attached to the head 200 of the frame tool 102 at the back surface 216. More specifically, the pole attachment and the head 200 may be positioned at an angle A2. In at least one example embodiment, the angle A2 may be approximately 90 degrees. In at least one example embodiment, the head 200 and pole attachment 202 of the frame tool 102 may be formed as a single component. The head 200 and the pole attachment 202 may have a height H. In some examples, the height H may range from approximately seven inches to approximately thirteen inches.

The pole attachment 202 may include a cylindrical piece composed of a ceiling 222 and a sidewall 224. The ceiling 222 may be attached to the back surface 216 of the head 200 of the frame tool 102. The sidewall 224 may be disposed annularly about the ceiling 222 and extend from the ceiling. The sidewall 224 may include one or more apertures 226 extending through the pole attachment 202. In other words, the pole attachment 202 may include a first aperture extending through the sidewall and a second aperture directly opposite from the first aperture. A cylindrical opening 228 may be formed within the pole attachment 202, between the ceiling and sidewall. The cylindrical opening 228 is configured to receive the pole 204. Additionally, the sidewall 224 may include a protrusion (not shown) extending into the cylindrical opening 226. The protrusion may be aligned with one of the apertures 226 and extend along a length of the sidewall 224.

With reference to FIGS. 6-7, the pole 204 extends between first and second ends 250, 252. The pole 204 may have a length L measured between the first and second end 250, 252. In at least one example embodiment, the length L may be at least nine feet. In at least one example embodiment, the pole 204 may be a telescopic pole having a first pole 254, a second pole 256, and a third pole 258 joined by a first collar 260 and a second collar 262. More specifically, the first pole 254 may be received in the second pole 256 and the second pole 256 may be received in the third pole 258. The first and second collars 260, 262 are operable to move between a locked position and an unlocked position. When the first collar 260 is in the locked position, the first and second poles 254, 256 are fixed. When the first collar 260 is in the unlocked position, the first pole 254 may translate within the second pole 256. Similarly, when the second collar 262 is in the locked position, the second and third poles 256, 258 are fixed. When the second collar 262 is in the unlocked position, the second pole 256 may translate within the third pole 258.

The pole 204 may include an indent 264 and one or more apertures 266. The indent 264 may be formed within the pole 204 and extend along the length L of the pole 204. In the example of the telescopic pole, the indent 264 may be formed in at least the first pole. The one or more apertures may be disposed within the indent. When the pole 204 is received within the pole attachment 202, the protrusion of the pole attachment 202 may be received within the indent of the pole 204, and the apertures of the pole 204 may be aligned with the apertures of the pole attachment 202. Thereby, the pole 204 is prevented from movement relative to the pole attachment 202 and/or head 200.

With reference to FIGS. 6-10, the poster tool 104 may include a head 300, a pole attachment 302, and the pole 204. The head 300 of the poster tool 104 includes a curved receiver. The curved receiver may include a circular portion 304 and a tangential or straight portion 306. The straight portion 306 may be attached to one end of the circular portion 304. Together, the circular and straight portions 304, 306 define a slot 308. The curved receiver may be operable to receive the poster such that the poster is positioned within the slot 308. The slot may not be formed in a complete circle. Accordingly, both ends of the circular portion 304 may be joined with the straight portion 306. More specifically, one end of the circular portion 304 is positioned approximately at an angle A3 from a horizontal plane. In at least one example embodiment, the angle A3 may range from about 90 degrees to about 120 degrees.

The head 300 of the poster tool 104 may have a width W′. In at least one example embodiment, the width W′ may range from about five (5) inches to about eight (8) inches. Additionally, the slot 308 may have a diameter D. In at least one example embodiment, the diameter D may range from about two (2) inches to about seven (7) inches. The head 300 and pole attachment 302 may have a height H′. In at least one example embodiment, the height may range from about six (6) inches to about eleven (11) inches. The height H′ may vary depending on the diameter D and the amount of tool registering onto the pole 204.

The pole attachment 302 may be positioned approximately perpendicular to the head 300 of the poster tool 104. In at least one example embodiment, the head and pole attachment 302 may be formed as a single component. The pole attachment 302 may include a ceiling 310 and a sidewall 312. The ceiling 310 may be attached to the head 300 of the poster tool 104. The sidewall 312 may be disposed annularly about the ceiling 310 and extend from the ceiling 310. The sidewall 312 may include one or more apertures 314 extending through the pole attachment 302. In other words, the pole attachment 302 may include a first aperture extending through the sidewall and a second aperture directly opposite from the first aperture. A cylindrical opening 316 may be formed within the pole attachment 302, between the ceiling 310 and sidewall 312. The cylindrical opening 316 is configured to receive the pole 204. Additionally, the sidewall 312 may include a protrusion (not shown) extending into the cylindrical opening 316. The protrusion may be aligned with one of the apertures 314 and extend along a length of the sidewall 312. When the pole 204 is received within the pole attachment 302, the protrusion of the pole attachment 302 may be received within the indent 264 of the pole 204, and the apertures of the pole 204 may be aligned with the apertures of the pole attachment 302. Thereby, the pole 204 is prevented from movement relative to the pole attachment 302 and/or head 300.

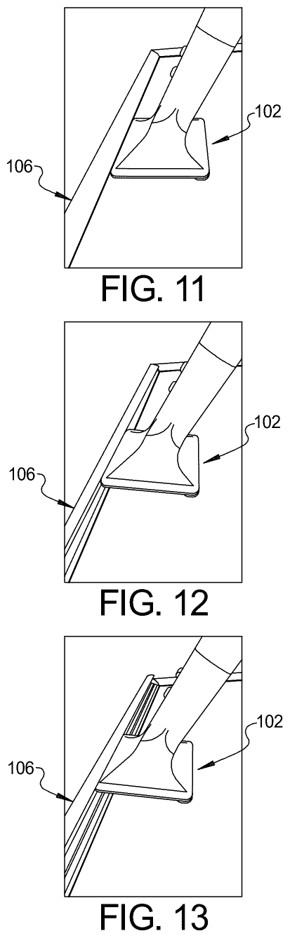

With reference to FIGS. 11-20, the operation of the poster replacement system will now be discussed in greater detail. Each of the panels 110,112, 114, 116 of the frame 106 may be operable to move from an open position to a closed position. More specifically, the first portion 118 may rotate about the hinge 122 to move the panel from the open position to the closed position. In the closed position, the first protrusion 124 of the first portion 118 may abut the second protrusion 126 of the second portion 120. Accordingly, the first and second portions 118, 120 may be secured in a snap-fit arrangement.

To replace a first poster with a second poster, a user may move the panels 110, 112, 114, 116 of the frame 106 from the closed position to the open position using the frame tool 102. More specifically, the user may grasp and maneuver the pole 204 of the frame tool 102 in order to position the head 200 of the frame tool 102. As shown in FIGS. 11-13, the user may position the top side of head 200 of the frame tool 102 under the first portion 118 of the top panel 110. Using the poster tool 104, the user may apply a force to the first portion 118 of the top panel 110, thereby moving the top panel 110 of the frame 106 from the closed position to the open position. More specifically, a force at the top side 206 of the head 200 may be applied toward the first portion 118 of the top panel 110 and a force at the bottom side 208 of the head 200 may be applied against the first poster.

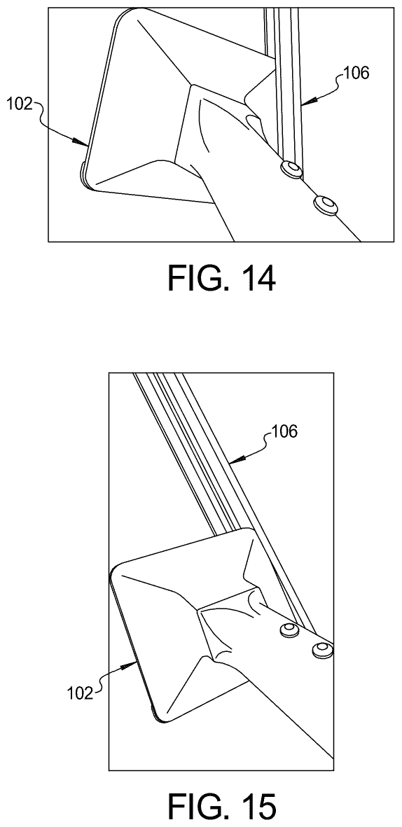

As shown in FIGS. 14-15, the user may position a corner 218 or lateral side of the head 200 of the frame tool 102 under the first portion 118 of the lateral side panels 114, 116 of the frame 106. Using the frame tool 102, the user may apply a force to the first portion 118 of the lateral side panels 114, 116, thereby moving the lateral side panels 114, 116 of the frame 106 from the closed position to the open position. Similarly, the user may position a bottom side 208 of the head 200 of the frame tool 102 under the first portion 118 of the bottom panel 112 of the frame 106. Using the frame tool 102, the user may apply a force to the first portion 118 of the lateral side panels 114, 116, thereby moving the bottom panel 112 of the frame 106 from the closed position to the open position. More specifically, a force at the bottom side 208 of the head 200 may be applied toward the first portion 118 of the bottom panel 112 and a force at the top side 206 of the head 200 may be applied toward the first poster.

Once the top, bottom, and lateral side panels 110, 112, 114, 116 of the frame 106 have moved from the closed position to the open position, the first poster is released from the frame 106.

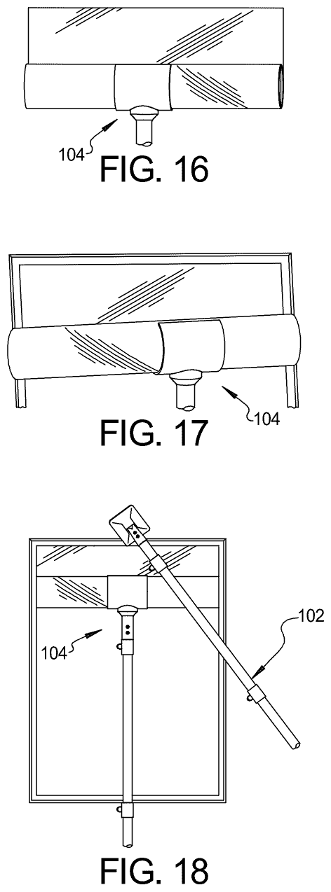

With reference to FIG. 16, the second poster is rolled and disposed within the slot 308 of the head 300 of the poster tool 104. More specifically, the second poster is rolled starting from a bottom of the second poster to a top of the second poster. Accordingly, the top of the second poster may be positioned adjacent to the straight portion 306 of the curved receiver. In at least one example embodiment, the top of the second poster may be positioned a distance away from the straight portion 306. For example, the distance may range from approximately five inches to approximately ten inches. In some at least one example embodiment, the second poster may include an inner layer and an outer layer. For example, the inner layer poster may include content to be displayed and the outer layer poster may be a protective film. Accordingly, the inner and outer layers of the second poster may be rolled together before being positioned within the slot 308 of the head 300 of the poster tool 104.

In at least one example embodiment, the second poster may be a large size. The second poster may be disposed within two poster tools 104 such that one rolled portion of the second poster is positioned within one poster tool and another rolled portion of the second poster is positioned within another poster tool. The two poster tools may be mounted to the same pole assembly.

As shown in FIG. 17, the user may position the top of the second poster within the top panel 110 of the frame 106 between the first and second portions 118, 120 using the poster tool 104. Once the top of the second poster is in a desired position, the user may use the frame tool 102 to move the top panel 110 of the frame 106 from the open position to the closed position. As shown in FIG. 18, a force is applied to the first portion 118 of the top panel 110 using the bottom side of the head 200 of the frame tool 102. Using the pole 204, the user may move the poster tool 104 downwards such that the head 300 of the poster tool 104 moves from near the top panel 110 of the frame 106 to the bottom panel 112 of the frame 106. As the poster tool 104 moves downward, the second poster is un-rolled and positioned within the opening of the frame 106. The frame tool 102 can be used to further adjust the position of the second poster relative to the frame 106.

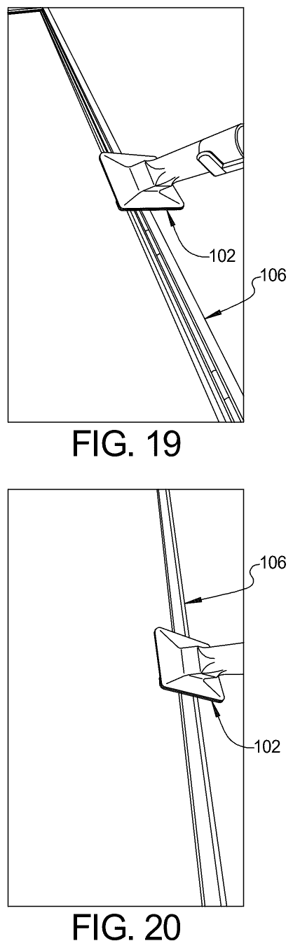

With reference to FIGS. 19-20, the user may move the lateral side panels 114, 116 of the frame 106 from the open position to the closed position by applying a force to the first portion 118 of lateral side panels 114, 116 using the frame tool 102. Similarly, the user may move the bottom panel 112 of the frame 106 from the open position to the closed position by applying a force to the first portion 118 of the bottom panel 112 using the frame tool 102.

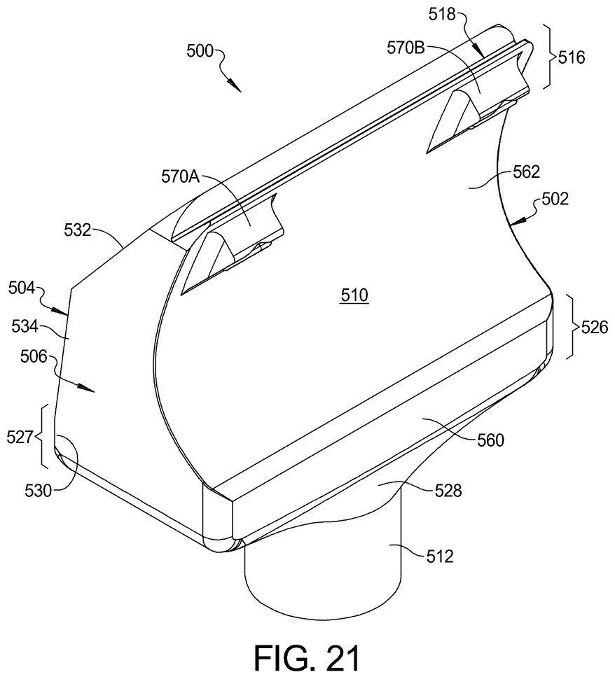

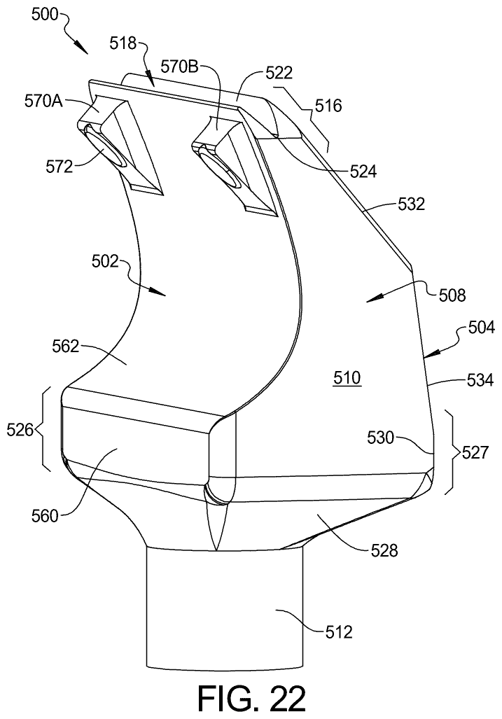

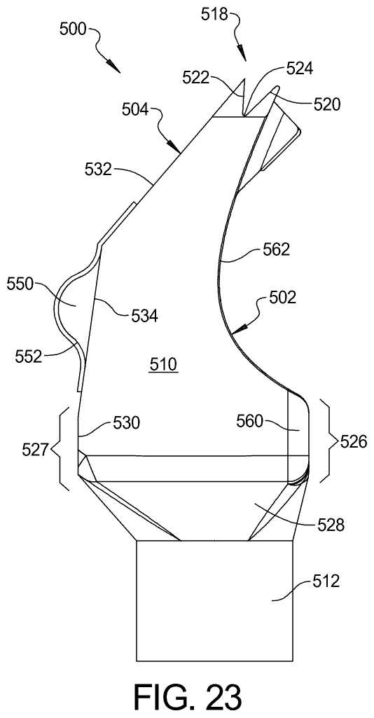

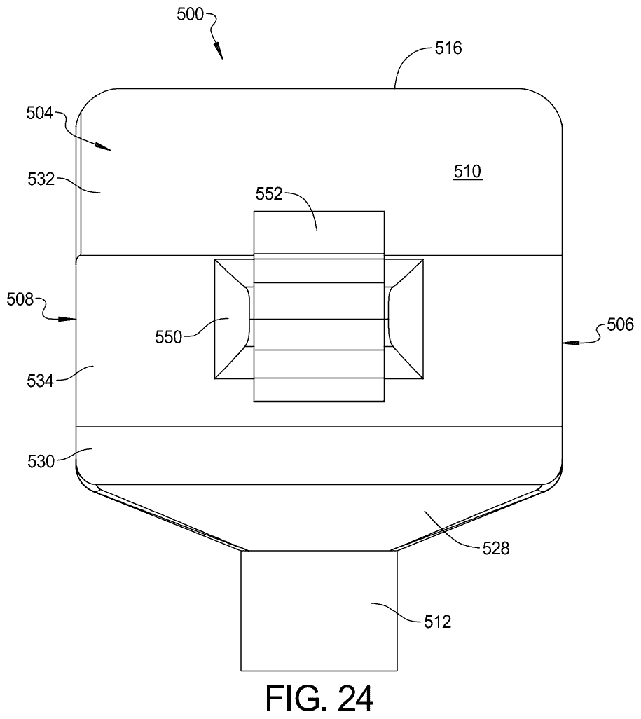

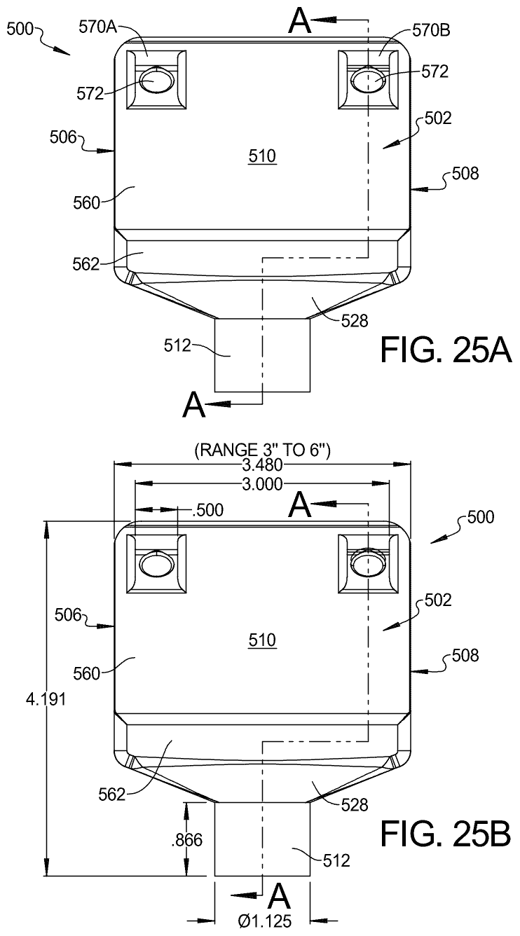

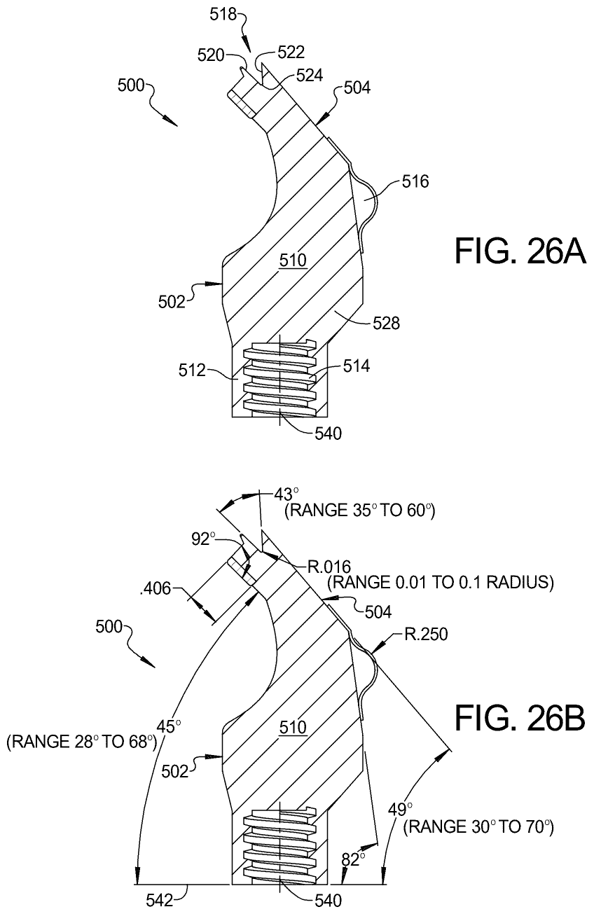

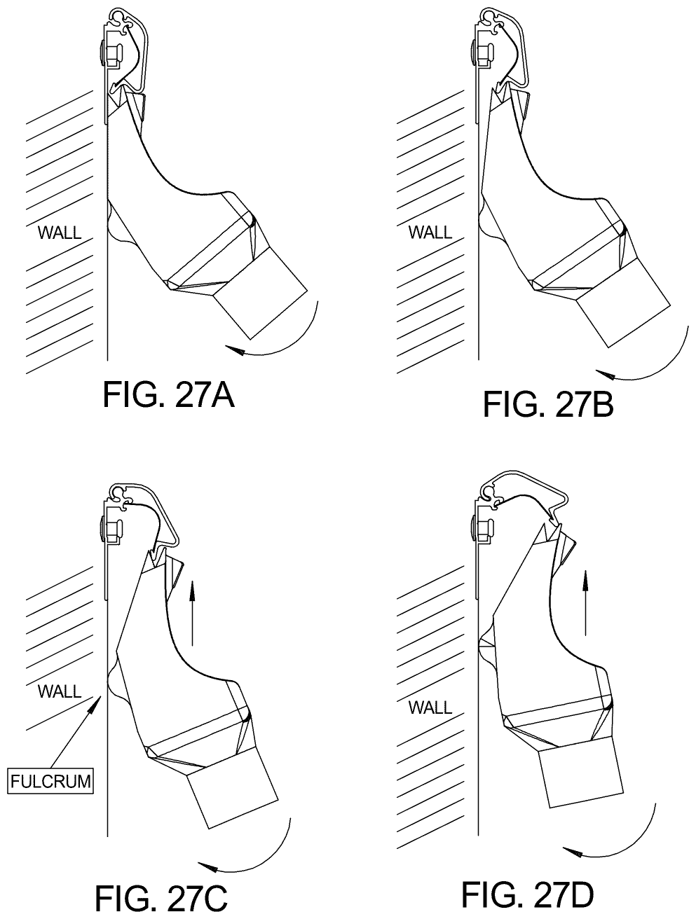

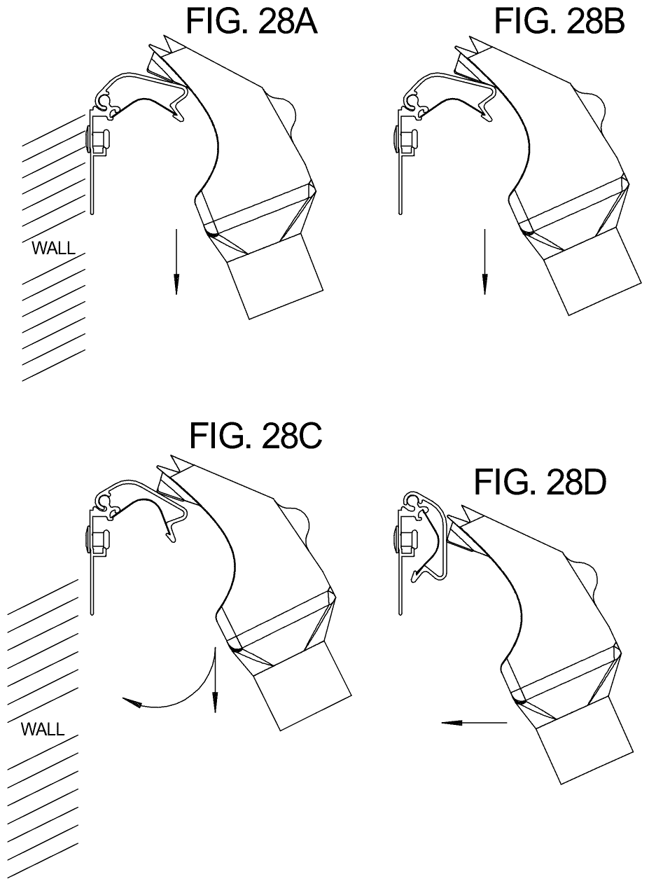

FIGS. 21-26D illustrate another example frame tool including a head 500 configured to be attached to and used with a pole, like the pole 204 illustrated in FIGS. 6-7. FIGS. 27A-27D illustrate an example method for opening a panel or rail of a poster frame using the frame tool 500. FIGS. 28A-28D illustrate and example method for closing the panel or rail of the poster frame suing the frame tool 500. As illustrated, the frame tool 500 may include have a first or front major panel or side 502 opposing a second or rear major panel or side 504 coupled on first and second sides by first and second end plates or panels, or sides 506, 508. For example, the first end plate 506 may couple a first portion of the first major panel 502 to a first portion of the second major panel 504, and the second end plate 508 may couple a second portion of the first major panel 502 to a second portion of the second major panel 504 to form a body 510 that defines the head 500. The second portion of the first major panel 202 may be opposite to the first portion of the first major panel 502. The second portion of the second major panel 504 may be opposite to the first portion second major panel 504.

The first major panel 502 and the second major panel 504 may be further joined together at a third or bottom ends or sides 526, 527 and coupled to a pole attachment 512. The pole attachment 512 may have a diameter greater than or equal to about 12.7 millimeters (mm) to less than or equal to about 50.8 mm. In at least one example embodiment, the pole attachment 512 may have a diameter of about 25.4 mm. In at least one example embodiment, the head 500 may further include a collar 528 that couples the pole attachment 512 and the body 510. The collar 528 may be sloped between the pole attachment 512 and the bottom end 526 of the first major panel 502 and the bottom end 527 of the second major panel 504. Although not illustrated, it should be appreciated that the pole attachment 512, like the pole attachment 202 discussed above, may include a cylindrical piece including a top or ceiling and a sidewall 224, where the sidewall is disposed annularly about the ceiling and extends from the ceiling and is configured to be mated with a pole, like the pole 504 illustrated in FIGS. 6-7. For example, in at least one example embodiment, the pole attachment 512 may include a plurality of threads 514.

The first major panel 502 and the second major panel 504 may be further joined together at a fourth or top end or side 516 of the head 500. The top end 516 of the head 500 may oppose the bottom ends 526, 537 of the first and second major panels 502, 504. The top end 516 may include an angled recess 518 having a wedge or triangular shape. For example, the angled recess 518 may include a first length or side 520 and a second length or side 522 that join together at respective first ends to form a point 524. In at least one example embodiment, an angle between a second end of the first length 520 and a second end of the second length 522 may be greater than or equal to about 35 degrees to less than or equal to about 60 degrees. In at least one example embodiment, the angle between a second end of the first length 520 and a second end of the second length 522 may be about 43 degrees. The second end of the first length 520 is the furthest position of the first length 520 from the point 524. The second end of the second length 522 is the furthest position of the second length 522 form the point 524. A depth of the point 524 may be greater than or equal to about 6.35 mm to less than or equal to about 38.1 mm, and in at least one example embodiment, optionally greater than or equal to about 6.35 mm to less than or equal to about 25.4 mm, from the second end of the first length 520 and/or the second end of the second length 522. The angle and the depth may be selected in response to a thickness of an edge of a frame to be adjusted by the head 500. For example, as illustrated in FIGS. 27A-27D, the recessed portion 518 may be configured to receive a portion of the frame panel or rail during the transition of the frame from a close state to an open state.

In at least one example embodiment, the second major panel 504 of the head 500 may include a first rear surface 530, a second rear surface 532, and a third rear surface 534 disposed between and connecting the first and second rear surfaces 530, 532. The first rear surface 530 may define the bottom end 527 of the second major panel 504. In at least one example embodiment, the first rear surface 520 be substantially linear surface that is substantially parallel with a major axis 540 of the pole attachment 512. The second rear surface 532 may be angled towards the first major panel 502. The angle of the second rear surface 532 may be selected such that, as illustrated in FIG. 27A, the second rear surface 532 lies flush with the frame as the head 500 slides towards the frame panel or rail to move the panel or rail from the closed position to the open position. In at least one example embodiment, an angle between a minor axis 542 of the pole attachment 512 and a major axis of the second rear surface 532 may be greater than or equal to about 30 degrees to less than or equal to about 70 degrees. In at least one example embodiment, the angle between the minor axis 542 of the pole attachment 512 and a major axis of the second rear surface 532 may be optionally about 49 degrees. The minor axis 542 of the pole attachment 512 may be perpendicular to the major axis 540 of the pole attachment 512. As illustrated, the third rear surface 534 may be angled between the first rear surface 530 and the second rear surface 532.

In at least one example embodiment, a fulcrum 550 may extend from the third rear surface 534. The fulcrum may be in the shape of a hump and may be formed separate from the rest of the body 510 and attached thereto or formed integral with the rest of the body 510. A peak of the fulcrum 550 may have a height greater than or equal to about 12.7 mm to less than or equal to about 25.4 mm. As seen in FIGS. 27A-27D, the fulcrum 550 may act as a pivot point as the frame tool is used to move a panel of a frame from a closed position to an open position. In at least one example embodiment, at least portion of the second major panel 504, including for example, one or more portions of the fulcrum 550, may be covered with a second material 552 that is different from a first material forming the body 510. In at least one example embodiment, the fulcrum 550 may be formed from the second material. In each instance, the second material 552 may be selected to protect the poster held within and/or transferred from a frame. In at least one example embodiment, the second material 552 may include felt. In at least one example embodiment, the second material 552 may have a major length greater than or equal to about 25.4 mm to less than or equal to about 38.1 mm.

In at least one example embodiment, the first major panel 502 of the head 500 may include a first front surface 560 and a second front surface 562. The first front surface 560 may define the bottom end 526 of the first major panel 502. The first front surface 560 may be a generally planar surface that is substantially parallel with the first rear surface 530. The second front surface 562 may include a concave surface, where an angle between the minor axis 542 of the pole attachment 512 and a portion of the concave surface near the top end 516 of the head 500 may be greater than or equal to about 28 degrees to less than or equal to about 68 degrees. In at least one example embodiment, the angle between the minor axis 542 of the pole attachment 512 and a portion of the concave surface near the top end 516 of the head 500 may be about 45 degrees. The concave surface may be selected to help ensure sufficient clearance for the panels or rails of a frame from which a poster is being transferred to and/or from.

In at least one example embodiment, the first major panel 502 may further include one or more bumpers 570A, 570B that extend from a portion of the second front surface 562 near the top end 516 of the head 500. For example, as illustrated, the head 500 may include a first bumper 570A and a second bumper 570B. Although not illustrated, it should be recognized that, in at least one example embodiment, a single bumper bumpers may extend from the portion of the second front surface 562 near the top end 516 of the head 500. Further, in at least one example embodiment, two or more discontinuous bumpers may extend from the portion of the second front surface 562 near the top end 516 of the head 500. Further still, in at least one example embodiment, a continuous bumper may extend from the portion of the second front surface 562 near the top end 516 of the head 500. As illustrated in FIGS. 28A-28D, the bumpers 570A, 570B may act as guides when the frame tool is used to close the poster panel or rail after removal and insertion of the poster. In at least one example embodiment, the bumpers 570A, 570B may be formed with the same material as the body 510 and at least partially overlayed with a third material 572. In at least one example embodiment, the bumpers 570A, 570B may be formed from the third material 572. In each instance, the third material 572 may be the same as or different from the second material. The third material 572 may be selected to protect the frame as the frame tool is used to move the panel or rail of the frame from the opened position to the closed position.

In at least one example embodiment, a method for using the frame tool to move the frame panel or rail from the closed position to the opened position may include, as illustrated in FIGS. 27A-27D, positioning or aligning the second rear surface 532 of the head 500 substantially parallel with a major surface of the opening of the frame and moving the head 500 towards the target panel or rail. When the top end 516 of the head 500 hits the panel or rail, the head 500 may pivoted about the fulcrum 550 to lift the panel or rail from the closed position to the opened position.

In at least one example embodiment, a method for using the frame tool to move the frame panel or rail form the opened position to the closed position may include, as illustrated in FIGS. 28A-28D, position or aligning the second front surface 562 with an exterior surface of the panel or rail, where the bumpers 570A, 570B are used as guides to correctly align or position the frame tool with respect to the frame panel or rail, and applying pressure using the frame tool to move the panel or rail from the opened position to the closed position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A frame tool for placing a poster in a poster display or removing the poster from the poster display, the frame tool comprising:
a head having a first major panel that opposes a second major panel, the first major panel and the second major panel connected to a top end, the top end including an angled recess, and the first major panel including a concave surface.

2. The frame tool of claim 1, the frame tool further including a pole attachment defining a bottom end of the head away from the top end and configured to receive a pole.

3. The frame tool of claim 2, the pole attachment further including a plurality of threads on an interior, receiving surface configured to engage the pole.

4. The frame tool of claim 2, the first major panel further including a first substantially planar surface coupled to the concave surface and substantially parallel with a second substantially planar surface of the second major panel.

5. The frame tool of claim 4, wherein the first and second substantially planar surfaces are substantially parallel with a major axis of the pole attachment, and frame tool further including a sloped collar connecting the pole attachment to the first substantially planar surface and the second substantially planar surface.

6. The frame tool of claim 4, wherein the second substantially planar surface is a first rear surface and the second major panel further includes a second rear surface that is coupled to the top end and a third rear surface disposed between the first and second rear surfaces.

7. The frame tool of claim 6, wherein the second rear surface is angled inward towards the first major panel.

8. The frame tool of claim 7, wherein an angle between a minor axis of the pole attachment and a major axis of the second rear surface is greater than or equal to about 30 degrees to less than or equal to about 70 degrees.

9. The frame tool of claim 4, wherein an angle between a minor axis of the pole attachment and a portion of the concave surface coupled to the top end is greater than or equal to about 28 degrees to less than or equal to about 68 degrees.

10. The frame tool of claim 1, the first major panel further including one or more bumpers extending from the concave surface.

11. The frame tool of claim 10, wherein the one or more bumpers extend from a portion of the concave surface adjacent to the top end.

12. The frame tool of claim 11, wherein the head is formed of a first material, and the one or more bumpers include a second material different from the first material.

13. The frame tool of claim 11, wherein the head formed of a first material, and the one or more bumpers are at least partially coated with a second material.

14. The frame tool of claim 1, the second major panel further including a fulcrum.

15. The frame tool of claim 14, the fulcrum including a peak having a height greater than or equal to about 12.7 mm to less than or equal to about 25.4 mm.

16. The frame tool of claim 14, wherein the head is formed of a first material, and the fulcrum include a second material different from the first material.

17. The frame tool of claim 14, wherein the head is formed of a first material, and the fulcrum are at least partially coated with a second material.

18. The frame tool of claim 17, the second material at least partially coating the second major panel.

19. The frame tool of claim 1, the angle recess including a first length and a second length that join together at respective first ends to form a point, an angle between a second end of the first length and a second end of the second length being greater than or equal to about 35 degrees to less than or equal to about 60 degrees, the second end of the first length being a further position of the first length from the point, and the second end of the second length being a further position of the second length from the point.

20. A system for placing a poster in a poster display, the system comprising:
a frame having a top panel, a bottom panel, and lateral side panels connecting the top and bottom panels to define an opening, wherein each of the panels is movable between an open position and a closed position;
a frame tool having a first head and a first pole attached to the first head, wherein the frame tool is operable to move the panels of the frame between the open and closed positions; and
a poster tool having a second head and a second pole attached to the second head, wherein the second head includes a curved receiver having a slot, the curved receiver is configured to receive the poster within the slot, and movement of the poster tool in a direction from the top panel to the bottom panel of the frame is operable to position the poster within the opening of the frame.
